(19) United States
(12) Patent Application Publication
(10) Pub. No.: US 2006/0043796 A1
(43) Pub. Date: Mar. 2, 2006

(54) AC wall receptacle with integral DC power supply

(76) Inventor: James H. Biskup SR., Aliquippa, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/932,701

(22) Filed: Sep. 2, 2004

(51) Int. Cl. H02J 1/12

(52) U.S. Cl. 307/25

(57) ABSTRACT

A wall receptacle assembly includes an AC-to-DC power supply received in a wall receptacle. The power supply has an input for electrical connection to a source of AC power and an output for electrical connection to a DC power consumption device. A switch and/or an AC outlet is received in the wall receptacle for providing AC power to an AC power consumption device. The switch and the AC outlet each include terminals for electrical connection to a power terminal of a source of AC power and either the AC power consumption device or a neutral terminal of the source of AC power. If provided, the switch is operative for electrically connecting its terminals together thereby connecting the source of AC power to the AC power consumption device whereupon the connection of the power supply to the source of AC power is unaffected by operation of the switch.

### BACKGROUND OF THE INVENTION

1. Field of the Invention

The present invention relates to wall receptacles utilized to house plugs or switches in a structure.

2. Description of Related Art

The use of wall receptacles in building structures is well known in the art. Typically, wall receptacles are utilized to house switches that are connected between a source of AC Power and an AC power consumption device, or to house one or more electrical outlets connected to a source of AC power, wherein each electrical outlet is configured to mate with a plug for providing AC power to an AC power consumption device. Prior art wall receptacles are often insufficient in size to house more than the switch or the electrical outlet along with the associated wiring.

In many installations, AC-to-DC power supplies are being installed in a wall for converting AC power into DC power which is provided to one or more permanently installed, wall mounted DC power consumption devices, e.g., a built-in security system. One problem with installing an AC-to-DC power supply in a wall is that if it becomes necessary to gain access to the power supply for service, the power supply must either be removed from the wall or accessed via the wall. Moreover, in many instances, there is also a need to provide a dedicated supply of AC power to the power supply.

It would, therefore, be desirable to overcome the above problems and others by providing a wall receptacle assembly that can house both an AC-to-DC power supply and a switch assembly or an outlet assembly within the same wall receptacle assembly. Other features of the present invention that overcome problems of the prior art will become apparent to those of ordinary skill in the art upon reading and understanding the following detailed description.

### SUMMARY OF THE INVENTION

The invention is a wall receptacle assembly that includes a wall receptacle and an AC-to-DC power supply received in the wall receptacle. The power supply has an input for electrical connection to a source of AC power and an output for electrical connection to a DC power consumption device. The assembly includes means for providing AC power to an AC power consumption device. The means for providing AC power is also received in the wall receptacle with at least a portion of the means for providing AC power positioned in the wall receptacle. The means for providing AC power includes a first terminal for electrical connection to one of a power terminal or neutral terminal of a source of AC power and a second terminal for connection to either the AC power consumption device or the other of the power terminal or neutral terminal of the source of AC power.

The means for providing AC power can include at least one of an AC outlet and a switch which is operative for electrically connecting the first and second terminals together to thereby connect the source of AC power to the AC power consumption device. The connection of the power supply to the source of AC power, however, is unaffected by the operation of the switch. The switch can be movable between a first position where the pair of terminals is electrically connected together and a second position where the pair of terminals is electrically isolated. The switch can include means for switching the switch between the first and second positions. The means for switching can include a toggle, a push button or a rotatable member.

A cover plate can cover the wall receptacle with at least a portion of the means for providing AC power accessible via an opening in the cover plate. An extender can be positioned between the wall receptacle and the cover plate. The extender can have an opening in communication with an interior of the wall receptacle. The cover plate can cover the opening in the extender. The means for providing AC power can be at least partially received in the opening of the extender.

The invention is also a method of producing a wall receptacle assembly. The method includes providing a wall receptacle and installing an AC-to-DC power supply in the wall receptacle. The power supply has an input for connection to a source of AC power and an output for connection to a DC power consumption device. A means for providing AC power is connected to the wall receptacle with at least a portion of the means for providing AC power positioned in the wall receptacle. The means for providing AC power has a first terminal for connection to one of a line conductor or a neutral conductor of an AC power supply line and a second terminal for connection to either an AC power consumption device or the other of the line conductor and the neutral conductor of the AC power supply line.

The means for providing AC power can include at least one of an AC outlet and a switch which is operative for electrically connecting the terminals together to connect the source of AC power to the AC power consumption device. The connection of the power supply to the source of AC power is unaffected by the operation of the switch.

A cover plate can be installed on the wall receptacle with at least a portion of the means for providing AC power accessible via an opening in the cover plate. An extender can be positioned on the wall receptacle. The extender can have an opening in which at least part of the means for providing AC power is positioned. The cover plate can be positioned over the opening in the extender on a side thereof opposite the wall receptacle.

The method can further include electrically connecting the line conductor to the input of the power supply and the first terminal of the means for providing AC power, electrically connecting the output of the power supply to the DC power consumption device, and electrically connecting the neutral conductor to the second terminal of the means for providing AC power or to the AC power consumption device.

### BRIEF DESCRIPTION OF THE DRAWINGS

FIG. 1 is a cross-sectional side view of a prior art wall switch in operative relation to a wall stud and wall board or plaster;

FIG. 2 is the wall switch of FIG. 1 including an AC-to-DC power supply;

FIG. 3 is the wall switch and power supply of FIG. 2 including an extender for increasing the volume of the wall switch receptacle;

FIG. 4 is a block diagram showing the electrical connection of the wall switch and power supply of FIGS. 2 and 3 to a source of AC power, an AC power consumption device, and a DC power consumption device; and

FIG. 5 is a block diagram of the wall switch receptacle of FIG. 4 housing an outlet assembly and power supply.

### DETAILED DESCRIPTION OF THE INVENTION

The present invention will be described with reference to the accompanying figures where like reference numbers correspond to like elements.

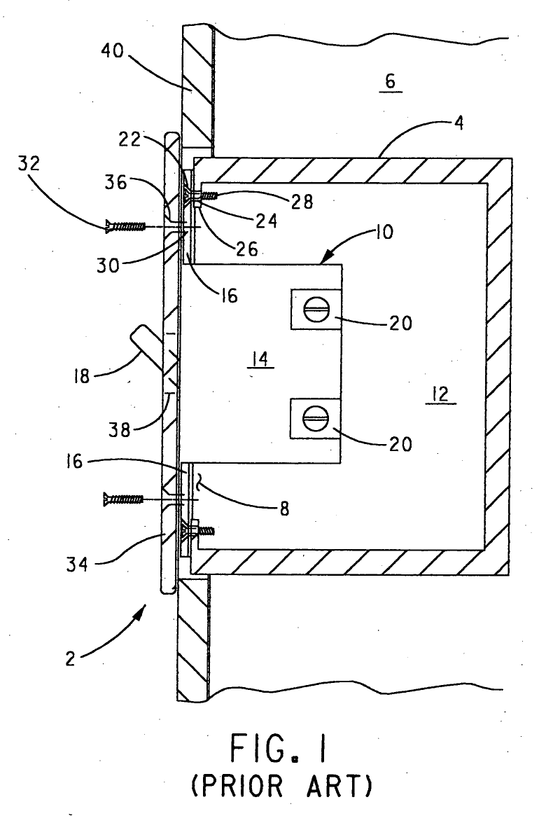

With reference to FIG. 1, a prior art wall switch 2 includes a receptacle 4 which can be secured to a stud 6 by suitable means (not shown) well known in the art, such as one or more nails. Receptacle 4 will typically be boxed shaped. However, this is not to be construed as limiting the invention since it is envisioned that receptacle 4 can have any suitable or desirable shape. Regardless of the shape of receptacle 4, receptacle 4 will typically include an opening 8 through which an electrical outlet assembly or electrical switch assembly 10 can be inserted into an interior 12 of receptacle 4. For purpose of describing the present invention, hereinafter, receptacle 4 will be described as having switch assembly 10 at least partially positioned inside interior 12 of receptacle 4. However, this is not to be construed as limiting the invention since it is envisioned that switch assembly 10 can be replaced by an electrical outlet of the type well known in the art.

Switch assembly 10 typically includes a switch body 14, one or more flanges 16 that extend to opposite sides of a front portion of switch body 14 and a switching means 18 for selectively electrically connecting a pair of terminals 20 together or for selectively electrically isolating the pair of terminals 20 from each other. Each terminal 20 is configured to mate with a stripped end of a conductor in a manner well known to those of ordinary skill in the art. Accordingly, the configuration of terminals 20 shown in the figures is not to be construed as limiting the invention.

The end of each flange 16 opposite switch body 14 includes therein a hole 22 that is configured to align with a threaded hole 24 in a lip 26 of receptacle 4. When a threaded hole 24 is aligned with a hole 22 of a flange 16, a threaded screw or bolt 28 can threadly mate with threaded hole 24 via hole 22 thereby securing corresponding flange 16 and, hence, switch assembly 10 to receptacle 4.

Receptacle 4 can include one or more removable sections (not shown) which can be removed to facilitate the routing of electrical wires into interior 12 of receptacle 4 in a manner known in the art. These removable parts have been omitted from FIGS. 1-3 for simplicity of illustration.

Each flange 16 can also include a threaded hole 30 configured to mate with a threaded screw or bolt 32. Each hole 30 and corresponding screw or bolt 32 can be utilized to secure an optional cover plate 34 to switch assembly 10 via corresponding holes 36 in cover plate 34. Wall switch 2 and stud 6 are shown in operative relation to wall board or plaster 40 for purpose of illustration.

Cover plate 34 can also include a slot or hole 38 through which means for switching 18 can project to facilitate user interaction therewith. Means for switching can be a toggle, as shown, a push button or a rotatable member.

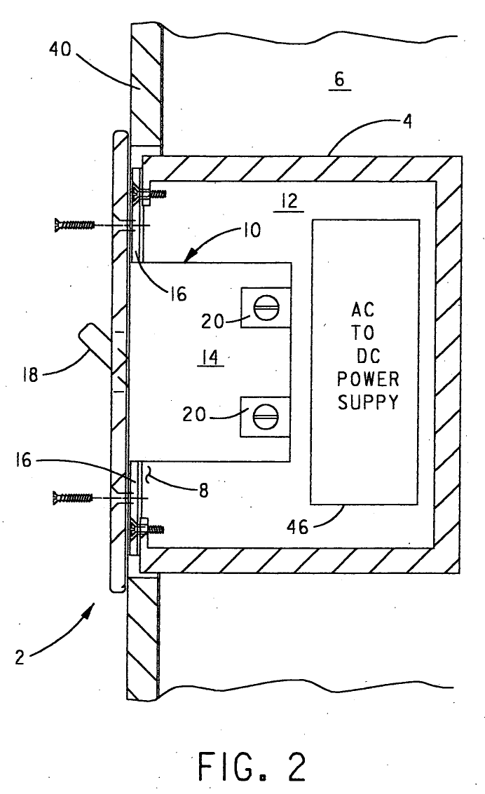

With reference to FIG. 2, and with continuing reference to FIG. 1, in accordance with the present invention, an AC-to-DC power supply 46 can be included in receptacle 4 of wall switch 2 for converting AC power input into receptacle 4 into DC power which can be supplied to one or more external DC power consumption devices.

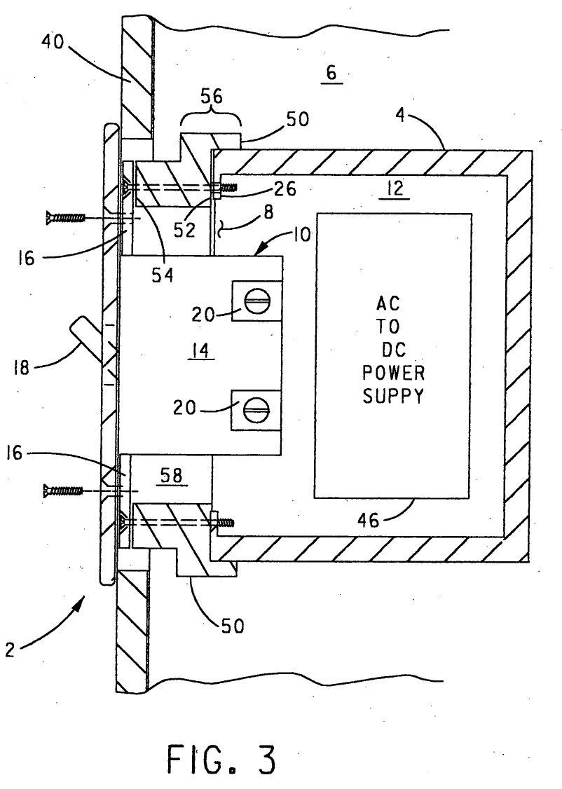

With reference to FIG. 3, and with continuing reference to FIGS. 1 and 2, as is well known in the art, a volume of interior 12 of receptacle 4 is often sized to receive switch body 14 of switch assembly 10 and the wires that connect to terminals 20 without much additional volume left for other fixtures, such as power supply 46. Accordingly, it would be desirable to increase the overall volume for receiving switch assembly 10 and power supply 46 without modifying receptacle 4 which is suitable for most applications. To this end, an extender 50 can be positioned between flanges 16 of switch assembly 10 and lips 26 of receptacle 4 for increasing the distance therebetween.

Extender 50 can have any suitable and/or desirable form. In the embodiment shown in FIG. 3, extender 50 has a shape somewhat similar to the shape of the edge of receptacle 4 surrounding opening 8. However, this is not to be construed as limiting the invention. In the embodiment shown in FIG. 3, extender 50 has a side 52 configured to abut sides of lips 26 opposite interior 12 of receptacle 4 and a side 54 configured to abut the sides of flanges 16 that face interior 12 of receptacle 4 when all or part of switch body 14 is received therein. If desired, extender 50 can include a lip 56 which, along with side 52, defines an L-shaped notch for receiving lip 26 and the end of receptacle 4 surrounding opening 8 therein. If desired, extender 50 can be configured whereupon lip 56 and side 52 receive the end of receptacle 4 surrounding opening 8 in a snap-fit relation to facilitate positioning of receptacle 4 and extender 50 on stud 6 and the connection of switch assembly 10 to extender 50 and receptacle 4.

As shown, extender 50 has an opening 58 that is in communication with interior 12 of receptacle 4 when extender 50 is mounted to the edge of receptacle 4 surrounding opening 8. The combination of opening 58 and interior 12 define a larger volume for receiving switch assembly 10 and power supply 46 thereby facilitating the mounting of power supply 46 within the same volume as switch assembly 10 while, at the same time, enabling electrical wires to be connected to terminals 20 of switch assembly 10 and to inputs and outputs of power supply 46, discussed hereinafter.

The embodiment of extender 50 shown in FIG. 3 is not to be construed as limiting the invention since the use of any suitable and/or desirable means for increasing the volume for receiving switch assembly 10 and power supply 46 over the volume of interior 12 alone is envisioned.

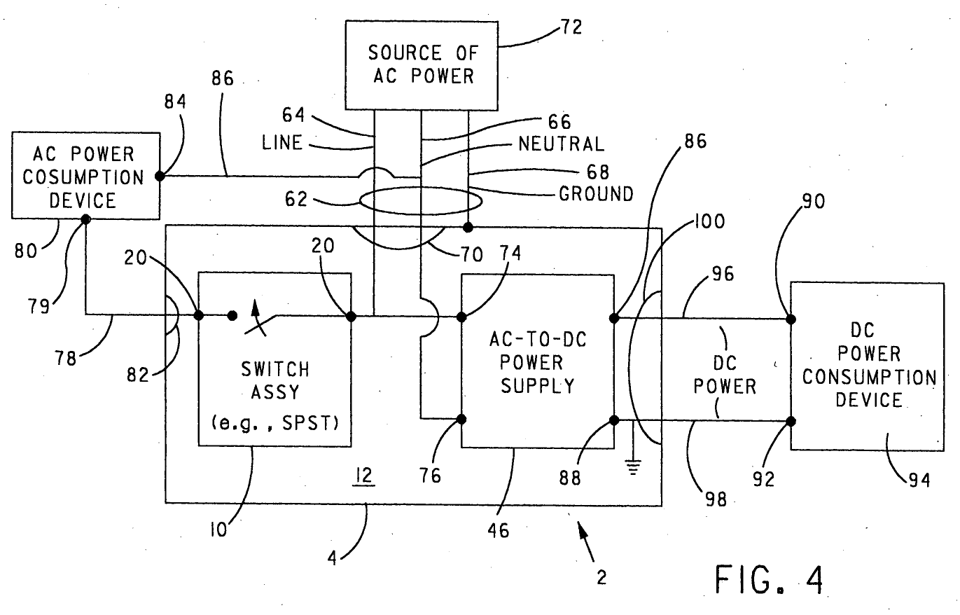

With reference to FIG. 4, and with continuing reference to FIGS. 1-3, the connection of switch assembly 10 to an AC power cable 62 and an AC power consumption device 80, and the connection of AC-to-DC power supply 46 to AC power cable 62 and a DC power consumption device 94 will be described. AC power cable 62 includes a line conductor 64, a neutral conductor 66 and a ground conductor 68. Line conductor 64 and neutral conductor 66 can be routed through a hole 70 in enclosure 4 from a source of AC power 72 to interior 12 of receptacle 4. Line conductor 64 can be connected to one terminal 20 of switch assembly 10 and to a power input 74 of power supply 46. Neutral conductor 66 can be connected a neutral input 76 of power supply 46. The other terminal 20 of switch assembly 10 can be connected to a conductor 78 which is also connected to a power terminal 79 of AC power consumption device 80 via a hole 82 in receptacle 4. AC power consumption device 80 includes a neutral terminal 84 which can be connected to neutral conductor 66 or a neutral terminal (not shown) of AC power source 72 via conductor 86.

Power supply 46 includes a power output terminal 86 and a ground output terminal 88 which are connected to a power terminal 90 and a ground terminal 92 of a DC power consumption device 94 via conductors 96 and 98, respectively, via a hole 100 in receptacle 4. Power supply 46 can supply DC power to DC power consumption device 94 via conductors 96 and 98.

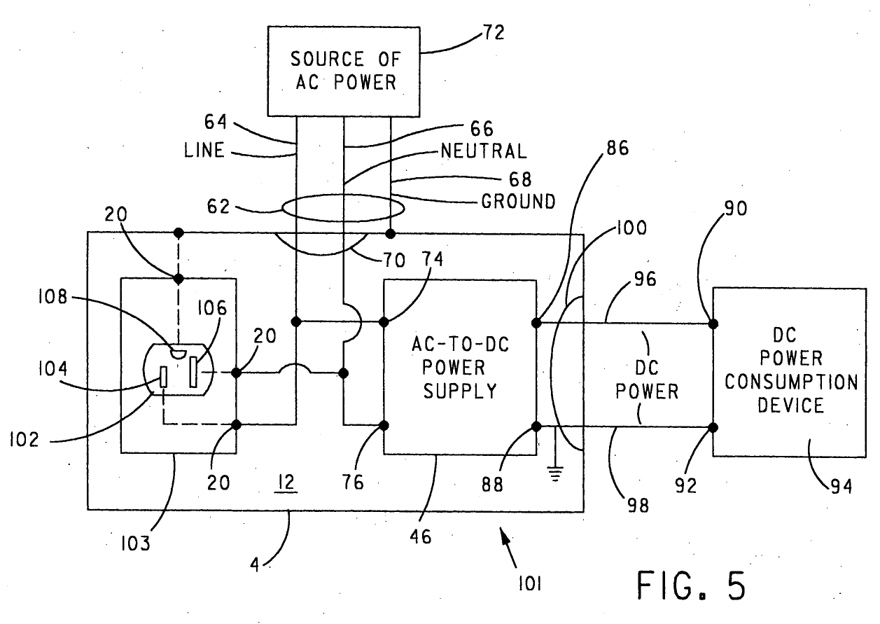

With reference to FIG. 5, and with continuing reference to FIGS. 1-4, alternatively, one or more electrical outlets 102 can be at least partially received inside interior 12 of receptacle 4 in place of switch 10 to define an outlet assembly 103 and a wall outlet 101 in accordance with the present invention. Each electrical outlet 102 includes a power contact 104, a neutral contact 106 and a ground contact 108 connected to line conductor 64, neutral conductor 66 and ground conductor 68, respectively, of AC power cable 62 via corresponding terminals 20 of electrical outlet 102. As discussed above, each electrical outlet 102 is configured to mate with a corresponding plug (not shown) for supplying AC power to an AC power consumption device, like AC power consumption device 80. The connection of AC-to-DC power supply 46 to the conductors of AC power cable 62 and DC power consumption device 94 is the same as described in connection with FIG. 4. Accordingly, a detailed description of these connections will not be included herein to avoid unnecessary redundancy.

The present invention has been described with reference to the preferred embodiments. Obvious modifications and alterations will occur to those of ordinary skill in the art. It is intended that the invention be construed as including all such modifications and alterations insofar as they come within the scope of the appended claims or the equivalents thereof.

The invention claimed is:

1. A wall receptacle assembly comprising:
a wall receptacle;
an AC-to-DC power supply received in the wall receptacle, the power supply having an input for electrical connection to a source of AC power and an output for electrical connection to a DC power consumption device; and
means for providing AC power to an AC power consumption device, the means for providing AC power at least partially received in the wall receptacle, the means for providing AC power including a first terminal for electrical connection to one of a power terminal and a neutral terminal of a source of AC power and a second terminal for connection to either the AC power consumption device or the other of the power terminal and the neutral terminal of the source of AC power.

2. The assembly of claim 1, wherein the means for providing AC power includes at least one of an AC outlet and a switch which is operative for electrically connecting the first and second terminals together to thereby connect the source of AC power to the AC power consumption device whereupon the connection of the power supply to the source of AC power is unaffected by the operation of the switch.

3. The assembly of claim 2, wherein the switch is movable between a first position where the pair of terminals is electrically connected together and a second position where the pair of terminals is electrically isolated.

4. The assembly of claim 3, wherein the switch further includes means for switching the switch between the first and second positions.

5. The assembly of claim 4, wherein the means for switching includes one of a toggle, a push button and a rotatable member.

6. The assembly of claim 1, further including a cover plate covering the wall receptacle with at least a portion of the means for providing AC power accessible via an opening in the cover plate.

7. The assembly of claim 1, further including an extender positioned between the wall receptacle and a cover plate, the extender having an opening in communication with an interior of the wall receptacle, the cover plate covering the opening in the extender, wherein the means for providing AC power is at least partially received in the opening of the extender.

8. A method of producing a wall receptacle assembly comprising:
providing a wall receptacle;
installing an AC-to-DC power supply in the wall receptacle, the power supply having an input for connection to a source of AC power and an output for connection to a DC power consumption device; and
connecting means for providing AC power to the wall receptacle with at least a portion of the means for providing AC power positioned in the wall receptacle, the means for providing AC power having a first terminal for connection to one of a line conductor and a neutral conductor of an AC power supply line and a second terminal for connection to either an AC power consumption device or the other of the line conductor and the neutral conductor of the AC power supply line.

9. The method of claim 8, wherein the means for providing AC power includes at least one of an AC outlet and a switch which is operative for electrically connecting the terminals together to connect the source of AC power to the AC power consumption device whereupon the connection of the power supply to the source of AC power is unaffected by the operation of the switch.

10. The method of claim 8, further including installing a cover plate on the wall receptacle with at least a portion of the means for providing AC power accessible via an opening in the cover plate.

11. The method of claim 8, further including positioning an extender on the wall receptacle, the extender having an opening in which at least part of the means for providing AC power is positioned.

12. The method of claim 11, further including positioning a cover plate over the opening in the extender on a side thereof opposite the wall receptacle.

13. The method of claim 8, further including:
electrically connecting the line conductor to the input of the power supply and the first terminal of the means for providing AC power;
electrically connecting the output of the power supply to the DC power consumption device; and
electrically connecting the neutral conductor to the second terminal of the means for providing AC power or to the AC power consumption device.
